(19) United States
(12) Patent Application Publication
(10) Pub. No.: US 2020/0287300 A1
(43) Pub. Date: Sep. 10, 2020

(54) Connection Terminal, Method Of Connecting Wires Using The Same And Pressing Die

(71) Applicants: Tyco Electronics (Shanghai) Co. Ltd., Shanghai (CN); TE Connectivity India Private Limited, Bangalore (IN); TE Connectivity Services GmbH, Schaffhausen (CH)

(72) Inventors: Sheng Li, Shanghai (CN); P. K. Senthil Kumar, Bangalore (IN); Kurt Allan Randolph, Middletown, PA (US); Yongjian Huang, Shanghai (CN); Weiguo Li, Shanghai (CN); Tongbao Ding, Shanghai (CN); Xing Tong, Shanghai (CN)

(73) Assignees: Tyco Electronics (Shanghai) Co. Ltd., Shanghai (CN); TE Connectivity India Private Limited, Bangalore (IN); TE Connectivity Services GmbH, Schaffhausen (CH)

(21) Appl. No.: 16/811,491

(22) Filed: Mar. 6, 2020

(30) Foreign Application Priority Data
Mar. 6, 2019 (CN) 201910170433.4

(51) Int. Cl. H01R 4/18; H01R 43/048; H01R 43/058

(52) U.S. Cl. CPC H01R 4/184; H01R 43/058; H01R 43/048; H01R 4/188

(57) ABSTRACT

A connection terminal made of a metal sheet includes a body portion having a first edge and a second edge extending in a longitudinal direction of the body portion and opposite to each other in a transverse direction of the body portion, a first wing extending from the first edge, and a second wing extending from the second edge. The first wing and the second wing are opposite to each other in the transverse direction of the body portion. A length of the first wing extending from the first edge is greater than a length of the second wing extending from the second edge. An inner surface of each of the first wing, the second wing, and the body portion has a plurality of first grooves.

### CROSS-REFERENCE TO RELATED APPLICATION

This application claims the benefit of the filing date under 35 U.S.C. § 119(a)-(d) of Chinese Patent Application No. 201910170433.4, filed on Mar. 6, 2019.

### FIELD OF THE INVENTION

The present invention relates to a connection terminal and, more particularly, to a connection terminal adapted to connect a plurality of wires.

### BACKGROUND

In connecting electrical equipment, it is sometimes necessary to use a connection terminal to electrically connect a plurality of wires to each other in a crimped manner. For example, when connecting three wires for conveying three-phase AC current, one end of the three wires needs to be electrically connected together. To facilitate the connection, a terminal clip is crimped to one end of the three wires to achieve an electrical connection between the three wires.

In one type of connection, the terminal clip is made of a conductive material, and the terminal clip is electrically connected to at least a part of the connected wires, so that a reliable electrical connection between all the wires may be further ensured. In the process of connecting the wires with such a terminal clip, some of the wires may move relative to the other wires under the clamping force of the terminal clip, resulting in poor electrical contact, inconsistent cross-sectional structure of the finally formed wires, and/or inability to crimp the wire securely.

### SUMMARY

A connection terminal made of a metal sheet includes a body portion having a first edge and a second edge extending in a longitudinal direction of the body portion and opposite to each other in a transverse direction of the body portion, a first wing extending from the first edge, and a second wing extending from the second edge. The first wing and the second wing are opposite to each other in the transverse direction of the body portion. A length of the first wing extending from the first edge is greater than a length of the second wing extending from the second edge. An inner surface of each of the first wing, the second wing, and the body portion has a plurality of first grooves.

### BRIEF DESCRIPTION OF THE DRAWINGS

The invention will now be described by way of example with reference to the accompanying Figures, of which:

FIG. 1 is a perspective view of a connection terminal according to an embodiment;

FIG. 2 is a sectional view of a body portion of the connection terminal of FIG. 1;

FIG. 3 is a rear perspective view of the connection terminal of FIG. 1 with a plurality of wires connected thereto and in an unbent state;

FIG. 4 is a front perspective view of the connection terminal of FIG. 3;

FIG. 5 is a perspective view of the connection terminal of FIG. 3 with a pressing die;

FIG. 6 is a perspective view of the connection terminal of FIG. 1 with a plurality of wires connected thereto and in a bent state;

FIG. 7 is a sectional view of the connection terminal, taken along line A-A of FIG. 6;

FIG. 8 is a sectional view of the connection terminal, taken along line B-B of FIG. 6;

FIG. 9 is a perspective view of the connection terminal of FIG. 1 connecting end portions of wires;

FIG. 10 is a perspective view of the connection terminal of FIG. 1 connecting portions of wires between end portions;

FIG. 11 is a perspective view of the connection terminal of FIG. 1 with a pressing die before bending;

FIG. 12 is a sectional view of the connection terminal of FIG. 1 with bent wings connected to a plurality of wires;

FIG. 13 is a sectional view of the connection terminal of FIG. 1 with bent wings connected to a plurality of wires;

FIG. 14 is a perspective view of a connection terminal according to another embodiment;

FIG. 15 is a sectional view of a body portion of the connection terminal of FIG. 14; and

FIG. 16 is another sectional view of the body portion of the connection terminal of FIG. 14.

### DETAILED DESCRIPTION OF THE EMBODIMENT(S)

Although the present disclosure will be described hereinafter in detail with reference to the attached drawings showing the embodiments of the present disclosure, it should be appreciated by those of ordinary skill in the art that the invention described herein may be modified and the technical effect of the present disclosure may be achieved at the same time. It should be understood that the description to the embodiments of the present disclosure in conjunction with the attached drawings is to convey a general concept of the present disclosure to the person of ordinary skill in the art, and is not intended to limit the present disclosure to the described exemplary embodiments.

Furthermore, in the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

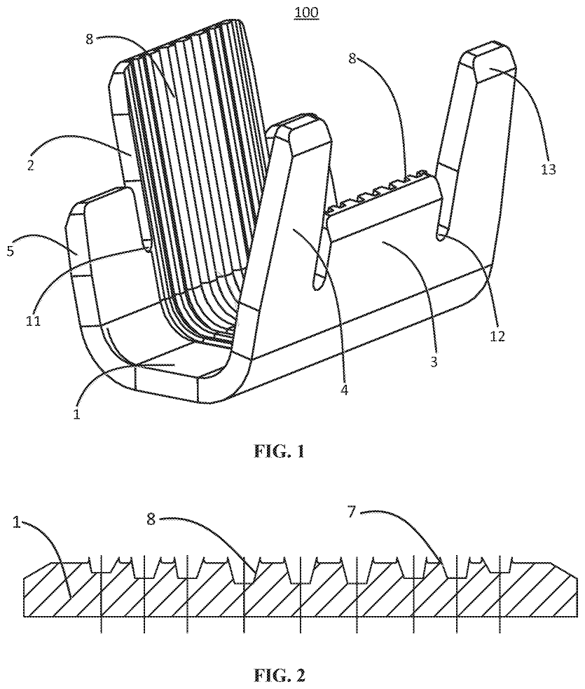

A connection terminal 100 according to an embodiment, as shown in FIG. 1, is made of a metal sheet such as a single copper sheet or a single stainless steel sheet, and includes a body portion 1, a first wing 2, and a second wing 3.

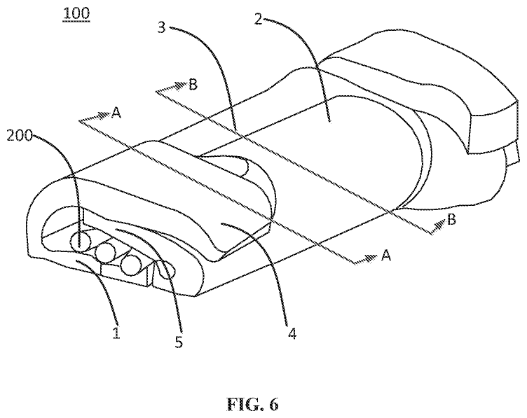

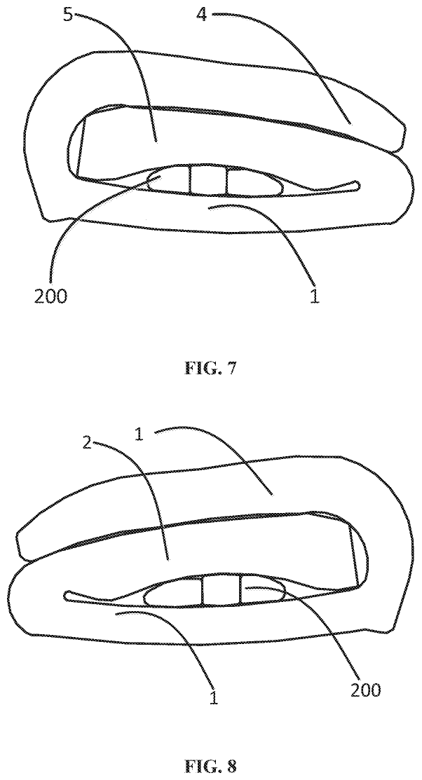

As shown in FIGS. 1 and 6-8, the body portion 1 has a substantially rectangular shape when unfolded into a plane, and has a first edge 11 and a second edge 12 extending in a longitudinal direction thereof and opposite to each other in a transverse direction thereof. The first wing 2 and the second wing 3 extend from the first edge 11 and the second edge 12, respectively. The first wing 2 and the second wing 3 are opposite in the transverse direction of the body portion 1, and a length of the first wing 2 extending from the first edge 11 of the body portion 1 is greater than a length of the second wing 3 extending from the second edge 12. Thus, as shown in FIGS. 6 and 8, in the case where the first wing 2 and the second wing 3 are bent so as to crimp the wires 200, the second wing 3 is held between the first wing 2 and the wires 200 by the first wing 2, so that the wires 200 is crimped by two layers of wings and thus may be securely held in the connection terminal 100 and all of the wires 200 are electrically connected to each other.

In an exemplary embodiment, as shown in FIGS. 1 and 2, an inner surface of each of the first wing 2, the second wing 3, and the body portion 1 have a plurality of first grooves 8. By providing the first grooves 8, the friction force applied to the wires 200 by the body portion 1, the first wing 2, and the second wing 3 may be increased, and the friction between the first wing 2 and the second wing 3 may also be increased, thereby retaining the wire 200 more securely in the connection terminal 100.

In an embodiment, each of the first grooves 8 is formed as a slot extending in the transverse direction on the first wing 2, the second wing 3, and the body portion 1. For example, nine slots, which are formed in a serration shape and each of which is symmetrical in the transverse direction, are arranged in the longitudinal direction. In this way, the retention of the connection terminal 100 in the longitudinal direction may be increased, preventing the wires 200 from being detached from the connection terminal 100 in the longitudinal direction. In an alternative embodiment, the first grooves 8 may be configured as a plurality of circular protrusions or a plurality of circular recessions.

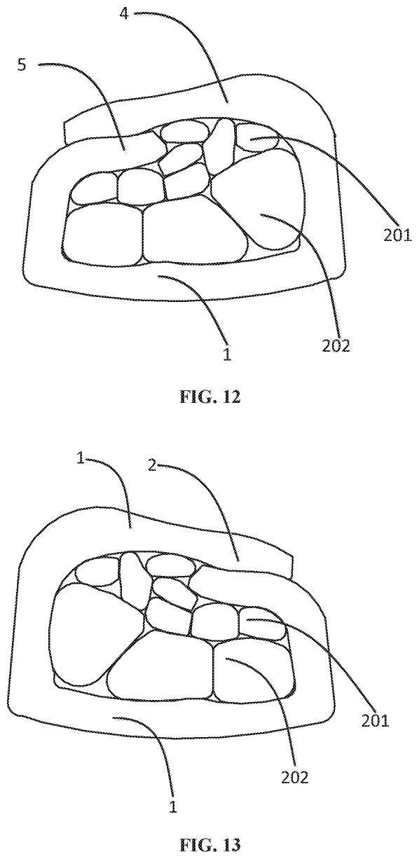

As shown in FIGS. 12 and 13, in an exemplary embodiment, the connection terminal 100 is adapted to retain more than three wires 200, such as ten wires. The wires 200 include a plurality of (e.g. seven) bare wires 201 and a plurality of (e.g. three) varnished wires 202. The varnished wire 202 includes a conductor and an insulating layer that covers the conductor.

An edge of each first groove 8, as shown in FIG. 2, has first burrs 7 extending away from the inner surfaces. Each varnished wire 202 is disposed to be in contact with at least one of the first wing 2, the second wing 3, and the body portion 1. Thus, in the case where the wires 200 are crimped by the first wing 2, the second wing 3 and the body portion 1 by a pressing die 300 (described in detail below), the burrs 7 pierce the insulating layer of the varnished wire 202 so that the connection terminal 100 may be electrically connected to the varnished wire 202. Further, by direct contact between the connection terminal 100 and the bare wires 201 and direct contact between the bare wires 201, all of the wires 200 including the bare wires 201 and the varnished wires 202 are electrically connected to each other. The varnished wire 202 is electrically connected to other wires when the insulation layer thereof is pierced, thereby avoiding the use of welding technology, reducing the cost of crimping, and reducing environmental pollution.

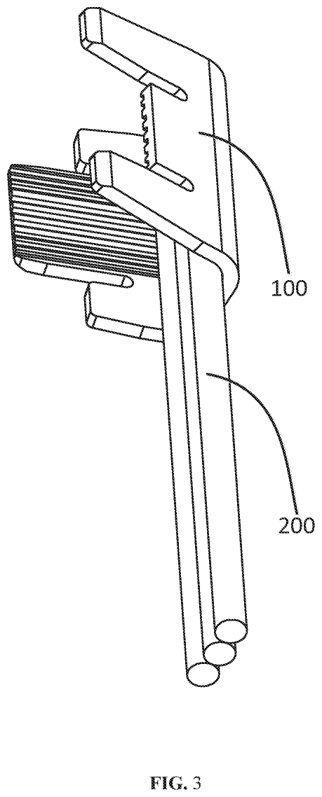

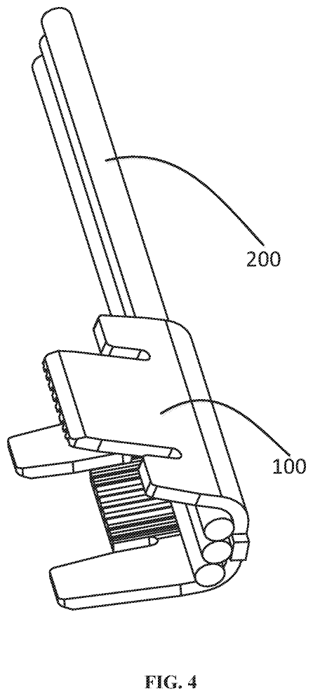

As shown in FIG. 1, the connection terminal 100 further includes at least one third wing 4 (for example, two third wings 4 are shown in FIG. 1) and at least one fourth wing 5 (for example, two fourth wings 5 are shown in FIG. 1) extending from the second edge 12 and the first edge 11 of the body portion 1, respectively. Each third wing 4 is opposite a respective fourth wing 5 in the transverse direction of the body portion 1, and a length of the third wing 4 extending from the second edge 12 of the body portion 1 is greater than a length of the fourth wing 5 extending from the first edge 11. Further, the first wing 2 and the at least one fourth wing 5 are alternately arranged on the first edge 11, and the second wing 3 and the at least one third wing 4 are alternately disposed on the second edge 12. For example, as shown in FIG. 3, the first wing 2 having a longer length is located between two fourth wings 5 having a shorter length, and the second wing 3 having a shorter length is located between two third wings 4 having a longer length.

The connection terminal 100 according to an embodiment has a two-dimensional structure, and the wings 2-5 perform overlapping and crimping on the wires 200 from two dimensions, and the wings 2-5 at the front end (for example, the third wing 4 and the fourth wing 5) overlap towards one side of the body portion 1 to crimp the wires 200, and the wings 2-5 at the rear end (for example, the first wing 2 and the second wing 3) overlap towards the other side of the body portion 1 to crimp the wires 200. In this way, a plurality of wires 200 are subjected to balanced force, and are pressed by a plurality of wings 2-5 at a plurality of points to prevent the plurality of wires 200 from being concentrated or twisted toward a certain portion during the crimping process, thereby more reliably retaining the plurality of wires 200 together mechanically. The poor electrical contact between the wires 200 may be avoided, and the cross-sectional structure of the finally formed wires 200 is substantially uniform.

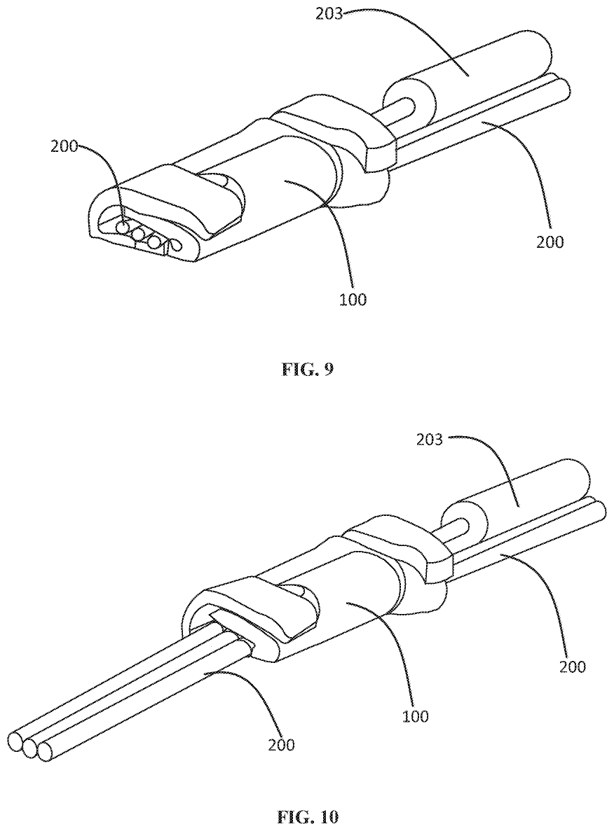

In one embodiment, as shown in FIG. 9, the connection terminal 100 may be crimped at the end portions of the plurality of wires 200 such that the plurality of wires 200 extend out of the connection terminal 100 from the same end of the connection terminal 100. In another embodiment, as shown in FIG. 10, the connection terminal 100 may be crimped at portions of the plurality of wires 200, each of which is located between the two end portions of the wire 200, that is, both end portions of each wire 200 extend out of the connection terminal 100. This increases the application flexibility of the connection terminal 100. In a further embodiment, the connection terminal 100 may crimp the wires 200 inserted therein from both ends of the body portion 1 such that one end of one wire 200 faces one end of the other wire 200.

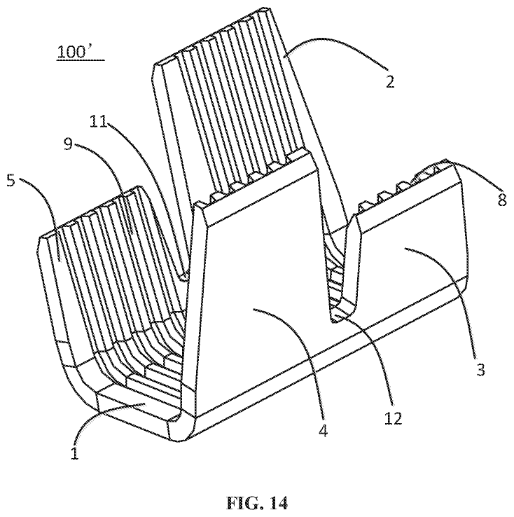

A connection terminal 100′ according to another embodiment is shown in FIGS. 14-16. As shown FIG. 14, a first wing 2 and a second wing 3 extend from the first edge 11 and the second edge 12, respectively. The first wing 2 and the second wing 3 are opposite in the transverse direction of the body portion 1, and a length of the first wing 2 extending from the first edge 11 of the body portion 1 is greater than that of the second wing 3 extending from the second edge 12. Inner surfaces of the first wing 2, the second wing 3 and the body portion 1 have a plurality of first grooves 8. Each of the first grooves 8 is formed as a slot extending in the transverse direction on the first wing 2, the second wing 3, and the body portion 1. An edge of each first groove 8 is provided with first burrs 7 extending away from the inner surfaces.

The connection terminal 100′, as shown in FIGS. 14-16, further includes one third wing 4 and one fourth wing 5 extending from the second edge 12 and the first edge 11 of the body portion 1, respectively. The third wing 4 is provided to be opposite to the fourth wing 5 in the transverse direction of the body portion 1, and a length of the third wing 4 extending from the second edge 12 of the body portion 1 is greater than that of the fourth wing 5 extending from the first edge 11. Further, the first wing 2 and the fourth wing 5 are alternately arranged on the first edge 11, and the second wing 3 and the third wing 4 are alternately disposed on the second edge 12. Inner surfaces of the third wing 4 and the fourth wing 5 have a plurality of second grooves 9. Each of the second grooves 9 is formed as a slot extending in the transverse direction on the third wing 4, the fourth wing 5, and the body portion 1. An edge of each second groove 9 has second burrs 10 extending away from the inner surfaces.

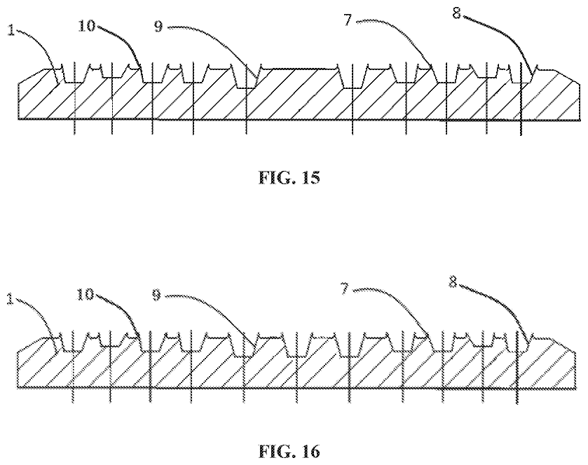

As shown in FIGS. 14 and 15, in one embodiment, no slot is provided at a portion of the body portion 1 between the first wing 2 and the fourth wing 5 (or between the second wing 3 and the third wing 4). As shown in FIGS. 14 and 16, in an alternative embodiment, slots further are provided at a portion of the body portion 1 between the first wing 2 and the fourth wing 5 (or between the second wing 3 and the third wing 4).

As shown in FIGS. 1 and 14, in one embodiment, the body portion 1 is pre-bent to have a substantially U-shaped cross section to facilitate placement of multiple wires within a generally U-shaped configuration. A slope 13 is provided on an outer surface of a free end of each of the first wing 2, the second wing 3, the third wing 4, and the fourth wing 5. The slope 13 may direct the wings 2-5 to move smoothly relative to a pressing die (described in detail below).

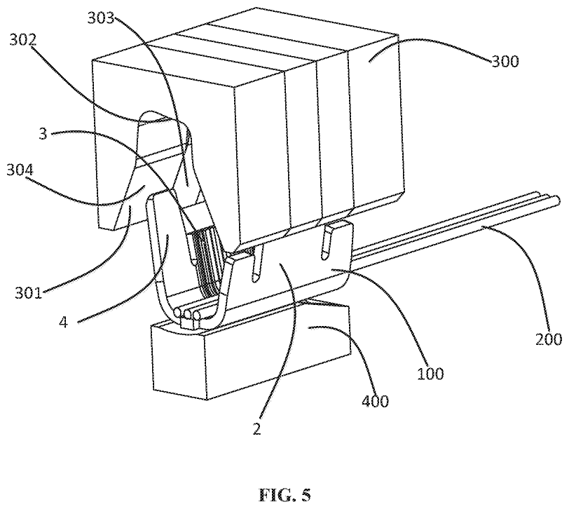

In an embodiment shown in FIG. 5, a pressing die 300 is adapted to press the connection terminal 100 according to any one of above-mentioned embodiments. The pressing die 300 has an opening 301 having a substantially U-shaped cross section, into which the first wing 2, the second wing 3, the third wing 4, and the fourth wing 5 of the connection terminal 100 are adapted to enter. As the pressing die 300 presses the connection terminal 100 against a support portion 400, the first wing 2, the second wing 3, the third wing 4, and the fourth wing 5 are all bent toward the body portion 1 so as to retain and crimp the wires 200 within the connection terminal 100. The first wing 2 is located outside the second wing 3 and the fourth wing 5 is located outside the third wing 4 (as shown in FIGS. 5 and 6).

In an embodiment, as shown in FIG. 5, a plurality of guiding grooves 303 and 304 having different slopes are provided on sidewalls of the U-shaped opening 301 of the pressing die 300. The plurality of guiding grooves 303 and 304 are configured such that the second wing 3 is bent toward the body portion 1 prior to the first wing 2 and, meanwhile, the fourth wing 5 is bent toward the body portion 1 prior to the third wing 4 as the pressing die 300 presses the connection terminal 100 against the support portion 400. For example, in the state shown in FIG. 5, the guiding groove 303 is adapted to guide the second wing 3 or the fourth wing 5 having a shorter length, and the guiding groove 304 is adapted to guide the first wing 2 or the third wing 4 having a longer length, and an angle of the guiding groove 303 with respect to a vertical axis and/or a height of the guiding groove 303 protruding into the opening 301 is larger than an angle of the guiding groove 304 with respect to a vertical axis and/or a height of the guiding groove 304 protruding into the opening 301. Thus, as shown in FIGS. 6-8, in the case where the first 2, second 3, third 4, and fourth 5 wings are bent so as to retain the wires 200, the second wing 3 is held between the first wing 2 and the wires 200 by the first wing 2, and the fourth wing 5 is held between the third wing 4 and the wires 200 by the third wing 4.

As shown in FIGS. 3-5, an embodiment of the present disclosure further provides a method for connecting a plurality of wires 200 by the connection terminal 100 according to any of the above embodiments. The method includes the following steps: as shown in FIGS. 3 and 4, pre-bending the body portion 1 of the connection terminal 100 so as to have a substantially U-shaped cross-section; placing a portion of the plurality of wires 200 within the bent body portion 1 having a substantially U-shaped cross-section; and pressing the connection terminal 100 by a pressing die 300. The pressing die 300 has an opening 301 having a substantially U-shaped cross section, into which the first wing 2, the second wing 3, the third wing 4, and the fourth wing 5 of the connection terminal 100 are adapted to enter. As the pressing die 300 presses the connection terminal against a support portion 400, the first wing 2, the second wing 3, the third wing 4, and the fourth wing 5 are all bent toward the body portion 1 so as to retain and crimp the wires 200 within the connection terminal 100, and the first wing 2 is located outside the second wing 3, and the fourth wing 5 is located outside the third wing 4.

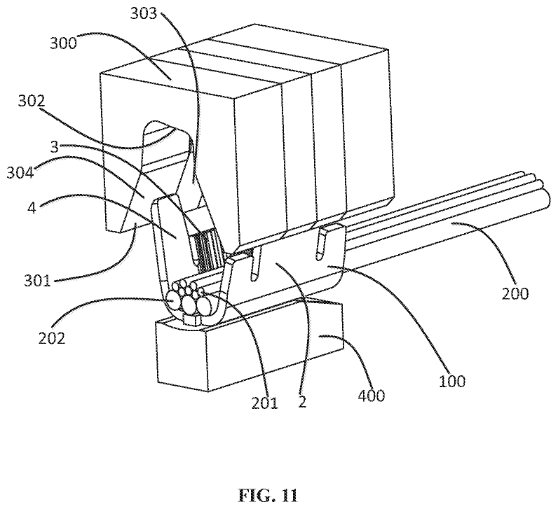

FIG. 11 shows the connection terminal 100 when a plurality of wires 200 are connected thereto, wherein wings 2-5 of the connection terminal 100 haven't been bent yet. The connection terminal 100 is adapted to retain more than three (for example, ten) wires 200. The wire 200 includes a plurality of (e.g. seven) bare wires 201 and a plurality of (e.g. three) varnished wires 202. The operation of connecting the ten wires shown in FIG. 11 is similar to the operation of connecting the three wires shown in FIG. 5, and will not be described again.

The connection terminal 100, 100′ according to the invention may achieve a firm mechanical connection and a reliable electrical connection of a plurality of wires 200 having different overall outer diameters, which widens the usage of the connection terminal 100, 100′ and simplifies the structure of the connection terminal 100, 100′. The wires 200 may include, for example, varnished wires 202 and/or bare wires 201 adapted to coils of a three-phase motor. The connection terminal 100, 100′ is adapted to crimp wires 200 with different conductor cross-sections (for example, Circular Mil Area (CMA)). In one embodiment, the milli-inch area (diameter (mm)/25.4)2*106) of the wire 200 may be in the range of 600 to 7000, for example, 600 to 3000 (model 62304-2), 1500 to 5000 (model 62306-2) and 3000-7000 (model 62304-2).

Therefore, the connection terminal 100, 100′ of the embodiment may crimp the wires 200 having different outer diameter ranges, reducing the management cost of the wires 200. The burrs 7, 10 are used to pierce the insulating layer of the wire 200 when crimping the wire 200, avoiding the process of melting the insulating layer and soldering the wire 200.

It should be appreciated for those skilled in this art that the above embodiments are intended to be illustrative, and not restrictive. For example, many modifications may be made to the above embodiments by those skilled in this art, and various features described in different embodiments may be freely combined with each other without conflicting in configuration or principle. Although several exemplary embodiments have been shown and described, it would be appreciated by those skilled in the art that various changes or modifications may be made in these embodiments without departing from the principles and spirit of the disclosure, the scope of which is defined in the claims and their equivalents.

What is claimed is:

1. A connection terminal made of a metal sheet, comprising:
a body portion having a first edge and a second edge extending in a longitudinal direction of the body portion and opposite to each other in a transverse direction of the body portion;
a first wing extending from the first edge; and
a second wing extending from the second edge, the first wing and the second wing are opposite to each other in the transverse direction of the body portion, a length of the first wing extending from the first edge is greater than a length of the second wing extending from the second edge, an inner surface of each of the first wing, the second wing, and the body portion has a plurality of first grooves.

2. The connection terminal of claim 1, wherein each first groove is a slot extending in the transverse direction in the first wing, the second wing, and the body portion.

3. The connection terminal of claim 2, wherein an edge of each first groove has a first burr extending away from the inner surface of each of the first wing, the second wing, and the body portion.

4. The connection terminal of claim 1, further comprising a third wing extending from the second edge and a fourth wing extending from the first edge.

5. The connection terminal of claim 4, wherein the third wing is opposite the fourth wing in the transverse direction of the body portion.

6. The connection terminal of claim 5, wherein a length of the third wing extending from the second edge is greater than a length of the fourth wing extending from the first edge.

7. The connection terminal of claim 6, wherein the first wing and the fourth wing are disposed alternately on the first edge and the second wing and the third wing are disposed alternately on the second edge.

8. The connection terminal of claim 7, wherein an inner surface of each of the third wing and the fourth wing has a plurality of second grooves.

9. The connection terminal of claim 8, wherein each second groove is a slot extending in the transverse direction on the third wing, the fourth wing, and the body portion.

10. The connection terminal of claim 9, wherein an edge of each second groove has a second burr extending away from the inner surface of each of the third wing, the fourth wing, and the body portion.

11. The connection terminal of claim 1, wherein the body portion is pre-bent to have a substantially U-shaped cross section.

12. The connection terminal of claim 4, wherein an outer surface of a free end of each of the first wing, the second wing, the third wing, and the fourth wing has a slope.

13. A method of connecting a plurality of wires, comprising:
providing a connection terminal made of a metal sheet and including a body portion having a first edge and a second edge extending in a longitudinal direction of the body portion and opposite to each other in a transverse direction of the body portion, a first wing extending from the first edge, and a second wing extending from the second edge, the first wing and the second wing are opposite to each other in the transverse direction of the body portion, a length of the first wing extending from the first edge is greater than a length of the second wing extending from the second edge, an inner surface of each of the first wing, the second wing, and the body portion has a plurality of first grooves;
pre-bending the body portion as a substantially U-shaped cross-section;
placing a portion of the plurality of wires within the body portion; and
pressing the connection terminal with a pressing die, the pressing die has an opening having a substantially U-shaped cross section, the first wing and the second wing enter the opening, the first wing and the second wing are bent toward the body portion so as to crimp the wires within the connection terminal as the pressing die presses the connection terminal against a support portion, the first wing is located outside the second wing after bending.

14. The method of claim 13, wherein a plurality of guiding grooves having different slopes are provided on a pair of sidewalls of the opening of the pressing die.

15. The method of claim 14, wherein the second wing is bent toward the body portion prior to the first wing as the pressing die presses the connection terminal against the support portion.

16. A pressing die adapted to press a connection terminal, comprising:
an opening having a substantially U-shaped cross section, a first wing and a second wing of the connection terminal enter the opening, the first wing and the second wing are bent toward a body portion of the connection terminal so as to crimp a wire within the connection terminal as the pressing die presses the connection terminal against a support portion, the first wing is located outside the second wing after bending.

17. The pressing die of claim 16, further comprising a plurality of guiding grooves having different slopes provided on a pair of sidewalls of the opening.

18. The pressing die of claim 17, wherein the second wing is bent toward the body portion prior to the first wing as the pressing die presses the connection terminal against the support portion.
